(19) United States
(12) Patent Application Publication
(10) Pub. No.: US 2026/0299726 A1
(43) Pub. Date: Oct. 1, 2026

(54) SEMICONDUCTOR DEVICE AND MEASUREMENT METHOD

(71) Applicant: Renesas Electronics Corporation, Tokyo (JP)

(72) Inventors: Masahiro ARAKI, Tokyo (JP); Eiji YAMANAKA, Tokyo (JP)

(73) Assignee: Renesas Electronics Corporation, Tokyo (JP)

(21) Appl. No.: 19/574,839

(22) Filed: Mar. 23, 2026

(30) Foreign Application Priority Data
Mar. 27, 2025 (JP) 2025-053089

(51) Int. Cl. G06F 3/041; G01D 5/16; G06F 3/044

(52) U.S. Cl. CPC G06F 3/0418; G01D 5/16; G06F 3/044

(57) ABSTRACT

A semiconductor device and measurement method capable of suppressing the effects of power supply noise is provided. The semiconductor device includes a terminal, a measurement unit that measures the current flowing to a capacitive touch element connected to the terminal via a first current path, and measures the current flowing to a resistive element instead of the touch element via a second current path branched from the first current path, and a correction unit that corrects the first current measurement value in the first current path based on the second current measurement value in the second current path.

### CROSS-REFERENCE TO RELATED APPLICATIONS

The disclosure of Japanese Patent Application No. 2025-053089 filed on Mar. 27, 2025, including the specification, drawings and abstract is incorporated herein by reference in its entirety for all purposes.

### BACKGROUND

The present invention relates to a semiconductor device and a measurement method and can be suitably used for a semiconductor device and a measurement method including a capacitive touch sensor circuit, for example.

There are disclosed techniques listed below.
[Patent Document 1] Japanese Unexamined Patent Application Publication No. 2015-12377
[Patent Document 2] Japanese Unexamined Patent Application Publication No. 2015-104005

Capacitive touch sensors are used in touch keys, touch screens, and the like. As related technology, Patent Documents 1 and 2 describe measuring the current flowing through the touch electrode in a capacitive touch sensor circuit.

### SUMMARY

However, in related technologies such as Patent Documents 1 and 2, it may not be possible to suppress the influence of power supply noise when measuring the current flowing through the touch electrode.

Other objects and novel features will become apparent from the description of this specification and the accompanying drawings.

According to one embodiment, the semiconductor device measures the current flowing through the capacitive touch element in the first current path and measures the current flowing through the resistive element instead of the touch element in the second current path branched from the first current path. The semiconductor device corrects the first current measurement value in the first current path based on the second current measurement value in the second current path.

According to the embodiment, the influence of power supply noise can be suppressed.

### BRIEF DESCRIPTION OF THE DRAWINGS

FIG. 1 is a configuration diagram showing a configuration example of a semiconductor device according to an examined example.

FIG. 2 is a configuration diagram showing a configuration example of the control unit of the semiconductor device according to an examined example.

FIG. 3 is a configuration diagram showing the general configuration of a semiconductor device according to an embodiment.

FIG. 4 is a configuration diagram showing a configuration example of a semiconductor device according to the first embodiment.

FIG. 5 is a configuration diagram showing a configuration example of the measurement circuit of the semiconductor device according to the first embodiment.

FIG. 6 is a configuration diagram showing a configuration example of the control unit of the semiconductor device according to the first embodiment.

FIG. 7A is a timing chart showing an operation example of the semiconductor device according to an examined example.

FIG. 7B is a timing chart showing an operation example of the semiconductor device according to the first embodiment.

FIG. 8A is a timing chart showing an operation example of the semiconductor device according to an examined example.

FIG. 8B is a timing chart showing an operation example of the semiconductor device according to the first embodiment.

FIG. 9A is a timing chart showing an operation example of the semiconductor device according to an examined example.

FIG. 9B is a timing chart showing an operation example of the semiconductor device according to the first embodiment.

FIG. 10 is a configuration diagram showing a configuration example of the measurement circuit of the semiconductor device according to the second embodiment.

### DETAILED DESCRIPTION OF EMBODIMENTS

The embodiments will be described with reference to the drawings. For clarity of explanation, the following description and drawings are appropriately omitted and simplified. In the drawings, the same elements are denoted by the same reference numerals, and a repetitive description thereof is omitted as necessary.

### Examination of Related Technology

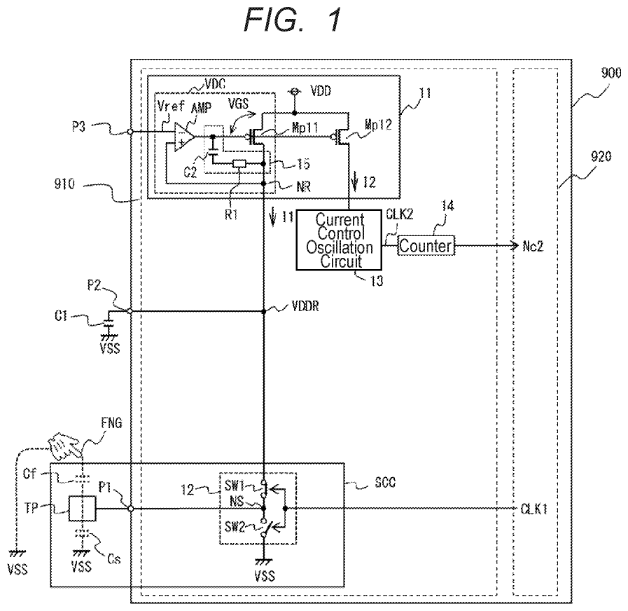

FIG. 1 shows a configuration example of a semiconductor device 900 according to an examined example. The example in FIG. 1 has the same configuration as the semiconductor device described in Patent Documents 1 and 2.

In the example of FIG. 1, the semiconductor device 900 includes external terminals P1 to P3, a measurement circuit 910, and a control unit 920. A touch electrode TP provided by a self-capacitance detection type touch key, which is an example of a capacitive method, is connected to terminal P1.

The measurement circuit 910 is a touch sensor circuit for the capacitive touch electrode TP. Specifically, the measurement circuit 910 measures the current corresponding to the capacitance of the touch electrode TP. The measurement circuit 910 can also be said to be a conversion circuit that converts the analog value of the capacitance of the touch electrode TP into a digital value (specifically, the count number Nc2 of the counter 14). The control unit 920 controls the measurement operation of the measurement circuit 910 and performs touch determination based on the measurement result of the capacitance of the touch electrode TP by the measurement circuit 910. Touch determination is to determine whether the user's finger FNG is touching the touch electrode TP (touch state) or not touching (non-touch state).

The measurement circuit 910 includes a current mirror circuit 11, a switch circuit 12, a current control oscillation circuit 13, and a counter 14. The combination of the touch electrode TP and the switch circuit 12 forms a switched capacitor circuit SCC.

The current mirror circuit 11 includes a power supply voltage drop circuit VDC and a p-type transistor Mp12. The power supply voltage drops circuit VDC steps down the power supply voltage VDD and generates a voltage VDDR, which is maintained at a desired voltage value, at node NR.

Node NR is connected to terminal P2. A capacitor C1 is connected to terminal P2 to suppress fluctuations in voltage VDDR. One end of capacitor C1 is connected to terminal P2, and the other end is applied with the power supply voltage VSS (also called ground voltage). Capacitor C1 may be disposed inside the semiconductor device 900.

The power supply voltage drop circuit VDC includes a p-type transistor Mp11, an amplifier AMP, and a phase compensation circuit 15. The p-type transistor Mp11 has the power supply voltage VDD applied to its source and node NR connected to its drain. One input terminal of the amplifier AMP is connected to terminal P3, and the reference voltage Vref is applied through terminal P3. The other input terminal of the amplifier AMP is applied with the drain voltage of the p-type transistor Mp11 via node NR. The output terminal of the amplifier AMP is connected to the gate of the p-type transistor Mp11. The amplifier AMP controls the gate voltage of the p-type transistor Mp11 so that the drain voltage of the p-type transistor Mp11, i.e., the voltage of node NR, becomes equal to the reference voltage Vref. As a result, voltage VDDR is generated at node NR.

The phase compensation circuit 15 compensates the phase of the input and output of the amplifier AMP and suppresses the oscillation of the amplifier AMP. The phase compensation circuit 15 includes a capacitor C2 and a resistor R1 connected in series. One end of capacitor C2 is connected to the output terminal of the amplifier AMP (the gate of the p-type transistor Mp11). The other end of capacitor C2 and one end of resistor R1 are connected. The other end of resistor R2 is connected to node NR (the other input terminal of the amplifier AMP).

The p-type transistor Mp12 has the power supply voltage VDD applied to its source and the gate of the p-type transistor Mp11 connected to its gate. That is, the p-type transistor Mp11 and the p-type transistor Mp12 form the current mirror circuit 11. The drain of the p-type transistor Mp12 is connected to the current control oscillation circuit 13. The current driving capability (transistor size) of the p-type transistor Mp11 is set to supply the current I1 required by the switched capacitor circuit SCC. The current driving capability of the p-type transistor Mp12 is set to supply the current I2 required by the current control oscillation circuit 13.

The switch circuit 12 includes a switch SW1 and a switch SW2. Switch SW1 has node NR, which outputs voltage VDDR, connected to one end and node NS connected to the other end. Switch SW2 has the other end of switch SW1 connected via node NS to one end and the power supply voltage VSS applied to the other end. Node NS is connected to terminal P1.

The conductive state (on) and non-conductive state (off) of switch SW1 and switch SW2 change complementarily in response to clock CLK1. For example, during the low-level period of clock CLK1, switch SW1 is set to the conductive state, and switch SW2 is set to the non-conductive state. During the high-level period of clock CLK1, switch SW1 is set to the non-conductive state, and switch SW2 is set to the conductive state. Therefore, during the low-level period of clock CLK1, switch SW1 applies the voltage VDDR output by the power supply voltage drop circuit VDC to terminal P1. During the high-level period of clock CLK1, switch SW2 applies the power supply voltage VSS to terminal P1. As understood from the change in the logic level of clock CLK1 and the complementary conductive and non-conductive states of switch SW1 and switch SW2, the switch circuit 12 operates in the same manner as a CMOS inverter circuit.

The touch electrode TP connected to terminal P1 acts as one electrode of each of the two parasitic capacitances Cs and Cf. The other electrode of parasitic capacitance Cs corresponds to the ground wiring of the printed circuit board formed around the touch electrode TP (not shown). The other electrode of parasitic capacitance Cf corresponds to the finger FNG and the human body (not shown). The voltage of the other electrode of parasitic capacitances Cs and Cf is set to the ground voltage via the ground wiring and the finger FNG, respectively. The value of parasitic capacitance Cf increases as the distance between the touch electrode TP and the finger FNG decreases.

The switched capacitor circuit SCC, formed by the switch circuit 12 and the touch electrode TP, performs charging and discharging of the parasitic capacitances Cs and Cf formed on the touch electrode TP in synchronization with clock CLK1. During the low-level period of clock CLK1, the switch circuit 12 applies voltage VDDR to the touch electrode TP via terminal P1 and charges the parasitic capacitances Cs and Cf. During the high-level period of clock CLK1, the switch circuit 12 applies the power supply voltage VSS to the touch electrode TP via terminal P1 and discharges the parasitic capacitances Cs and Cf.

The current I1 supplied to the switched capacitor circuit SCC is the current obtained by dividing the value of voltage VDDR by the value of the equivalent resistance of the switched capacitor circuit SCC. The equivalent resistance of the switched capacitor circuit SCC varies depending on the distance between the finger FNG and the touch electrode TP. Therefore, when the finger FNG touches the touch electrode TP (enters a touch state), the equivalent resistance of the switched capacitor circuit SCC decreases as the value of the parasitic capacitance Cf increases, and the current I1 increases. Conversely, when the finger FNG moves away from the touch electrode TP (enters a non-touch state), the equivalent resistance of the switched capacitor circuit SCC increases as the value of the parasitic capacitance Cf decreases, and the current I1 decreases.

The current-controlled oscillator circuit 13 generates a clock CLK2 whose frequency changes according to the value of the output current I2 of the current mirror circuit 11. As the output current I2 increases, the frequency of the clock CLK2 increases. Conversely, as the output current I2 decreases, the frequency of the clock CLK2 decreases. The counter 14 outputs count number Nc2, which is the count of the clock CLK2 during a suitably set count time.

When the finger FNG is touching the touch electrode TP (during touch), the value of the current I1 output by the power voltage drop circuit VDC increases, and the value of the current I2 output by the current mirror circuit 11 also increases. When the finger FNG is away from the touch electrode TP (during non-touch), the value of the current I1 decreases, and the value of the current I2 also decreases. The change in the value of the current I2 depends on the change in the parasitic capacitance Cf of the touch electrode TP. That is, the count number Nc2 by counter 14 (the measured value of the current I2 corresponding to the current I1) can be said to be the measured value of the capacitance of the touch electrode TP. Therefore, by detecting the change in the count number Nc2 during the set count time and comparing it with a predetermined reference count value, it is possible to detect (determine touch) whether the finger FNG is touching the touch electrode TP.

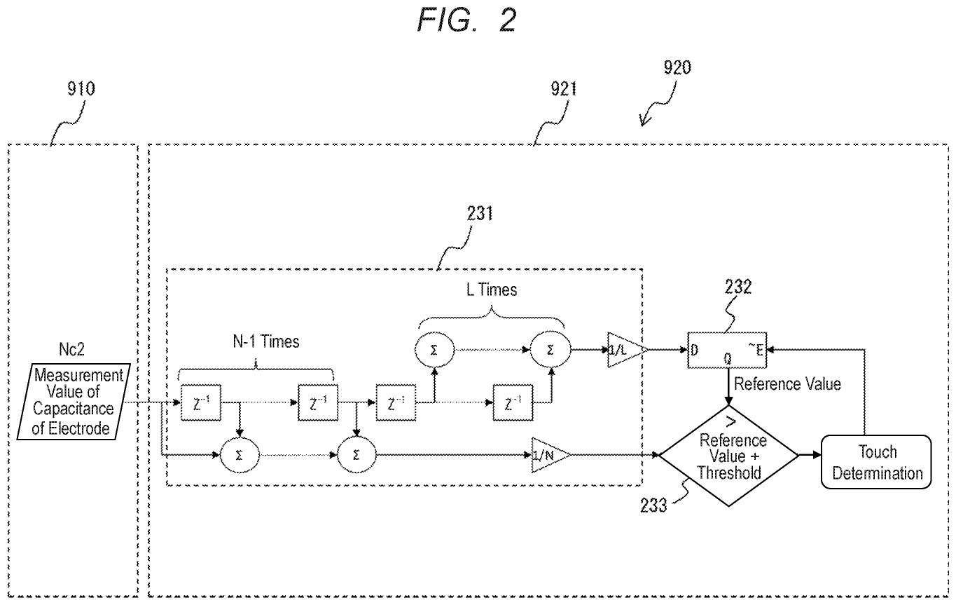

FIG. 2 shows a configuration example of the touch determination unit 921 included in the control unit 920 of FIG. 1. The touch determination unit 921 performs touch determination based on the measured value of the capacitance (count number Nc2) of the touch electrode TP.

In the example of FIG. 2, the touch determination unit 921 includes a moving average calculation unit 231, a reference value setting unit 232, and a capacitance determination unit 233. The moving average calculation unit 231 calculates the moving average of the measured value (count number Nc2) of the capacitance of the touch electrode TP. The moving average calculation unit 231 calculates the moving average of the measured values to set the reference value for touch determination and also calculates the moving average of the measured values for touch determination. For example, the moving average calculation unit 231 calculates the moving average of L measured values when not touching to set the reference value. Additionally, the moving average calculation unit 231 calculates the moving average of N measured values for determination during touch determination. For example, L>N.

The reference value setting unit 232 sets the reference value for performing touch determination. The reference value setting unit 232 sets the moving average result of L measured values when not touching as the reference value in the capacitance determination unit 233. The reference value setting unit 232 fixes the reference value during touch determination, that is, during the period when it is determined to be in a touch state.

The capacitance determination unit 233 compares the moving average result of N measured values for determination with the reference value+threshold and determines the presence or absence of touch based on the comparison result. In other words, it compares the difference between the measured value and the reference value (measured value-reference value) with the threshold. The capacitance determination unit 233 determines that it is in a touch state if the measured value for determination is greater than the reference value+threshold. The capacitance determination unit 233 determines that it is in a non-touch state if the measured value for determination is less than the reference value+threshold.

The inventors examined the operation when ripple noise is mixed into the power supply voltage VDD that supplies power to the capacitive touch sensor circuit in an examined example and identified the following issues. Specifically, consider that ripple noise is mixed into the power supply voltage VDD in the configuration of FIG. 1. Then, the fluctuation of the power supply voltage VDD is transmitted via the phase compensation circuit 15 to the p-type transistor Mp11 of the current mirror circuit 11, causing the gate-source voltage VGS of the p-type transistor to fluctuate. When the gate-source voltage VGS of the p-type transistor Mp11 fluctuates, the current I2 for measuring the change in the parasitic capacitance Cf of the touch electrode TP fluctuates, and the measured value of the current I2 (count number Nc2) fluctuates. As a result, there is a problem where the touch on the touch electrode TP cannot be detected due to the influence of ripple noise, or a false detection of touch occurs even when not touched.

It should be noted that measurement data fluctuates due to changes in circuit characteristic values caused by temperature changes. In contrast, as in the configuration of FIG. 2, by updating the reference value for detecting touch with the moving average of the measured values when not touching, the influence of gradual fluctuations can be removed. Additionally, by stopping the change of the reference value during the period when it is determined to be touched, it is possible to prevent a situation where it is determined as not touched midway during a long touch. If there is a sufficient difference between the rate of change in measured values due to touch and the rate of change due to temperature, this method can suppress the decline in determination accuracy. However, when the difference in the rate of change between the two is small, it becomes difficult to decide whether to use a certain measured value for calculating the reference value, making algorithm adjustment difficult. Furthermore, the difference in temperature characteristics between the fluctuation of measured values due to touch and the fluctuation due to ripple noise also makes algorithm adjustment difficult.

### SUMMARY OF THE EMBODIMENT

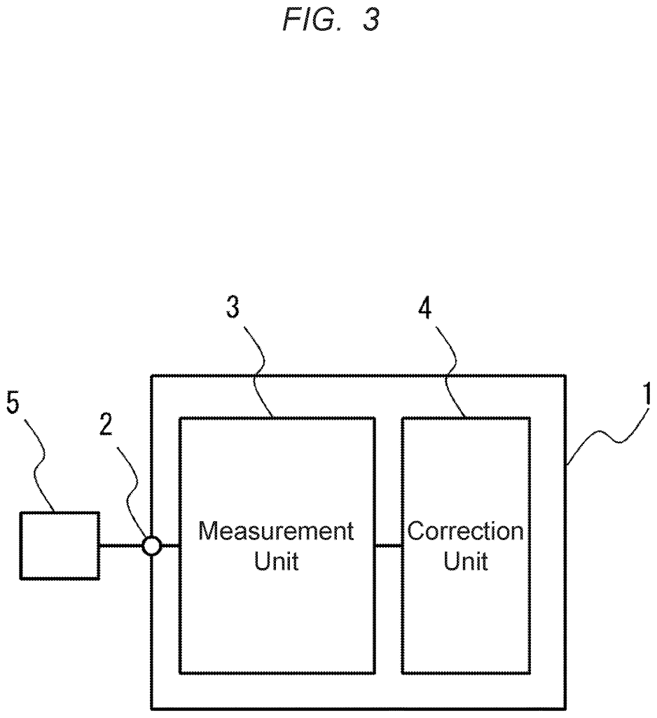

FIG. 3 shows a summary configuration of the semiconductor device 1 according to the embodiment. Semiconductor device 1 is a semiconductor device equipped with a capacitive touch sensor circuit. The capacitive touch sensor may be a self-capacitance type touch sensor or another type of touch sensor. For example, the capacitive touch sensor can be used in contact or non-contact applications such as touch keys, touch screens, touchless buttons, 3D gestures, and 2D gestures.

In the example of FIG. 3, semiconductor device 1 includes a terminal (e.g., first terminal) 2, a measurement unit 3, and a correction unit 4. A capacitive touch element (touch electrode) 20 is connected to terminal 2.

Measurement unit 3 has a first current path and a second current path branched from the first current path. Measurement unit 3 performs measurement by switching between the first current path and the second current path. Measurement unit 3 measures the current flowing through the touch element 5 connected to the terminal 2 in the first current path and measures the current flowing through a resistive element instead of the touch element 5 in the second current path.

The resistive element may be built into semiconductor device 1. In this case, the resistive element may be a resistive element for testing the characteristics of the circuit that measures the current flowing in the first current path. The resistive element may be externally attached to semiconductor device 1. In this case, the resistive element may be connected to the second terminal of the semiconductor device 1.

The correction unit 4 corrects the first current measurement value of the touch element 5 in the first current path based on the second current measurement value of the resistive element in the second current path. For example, the correction unit 4 may correct the first current measurement value by dividing it by the second current measurement value. The correction unit 4 may correct the first current measurement value by subtracting the second current measurement value from it.

Additionally, the semiconductor device 1 may include a touch determination unit that performs touch determination based on the corrected first current measurement value. For example, the touch determination unit may determine that it is in a touch state if the corrected first current measurement value is greater than the threshold and determine that it is in a non-touch state if the corrected first current measurement value is less than the threshold. Additionally, the touch determination unit may maintain the result of the touch determination before the second current measurement value changes significantly if the second current measurement value changes significantly from a predetermined value.

In this way, in the embodiment, the current flowing through the touch element in the first current path is measured, and the current flowing through the resistive element in the second current path is measured in the capacitive touch sensor circuit. Furthermore, the first current measurement value in the first current path is corrected based on the second current measurement value in the second current path. This allows for the correction of fluctuations in measurement values due to noise in the power supply voltage. Therefore, the influence on measurement values due to noise can be suppressed, and the accuracy of touch determination can be improved.

### First Embodiment

Next, the first embodiment will be described. In this embodiment, an example will be described in which the measured value of the current flowing through a load resistor built into the semiconductor device is used to correct the measured value of the capacitance of the touch electrode.

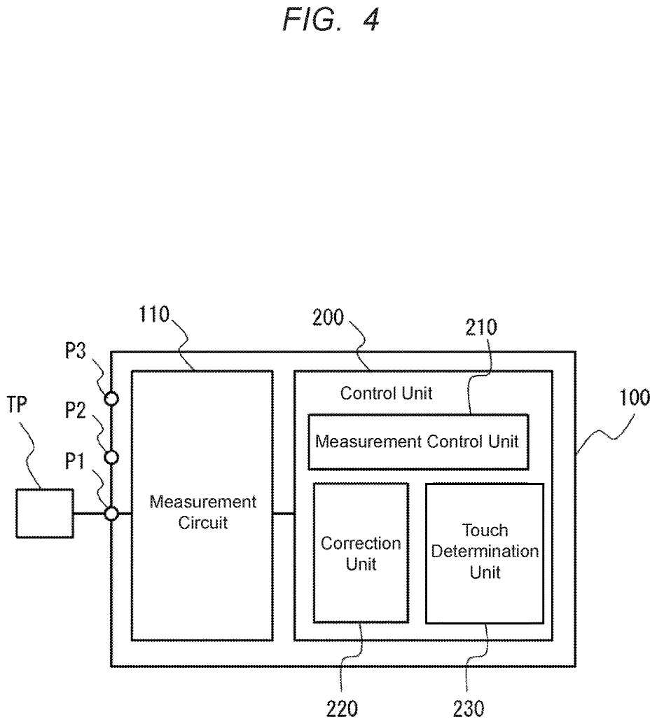

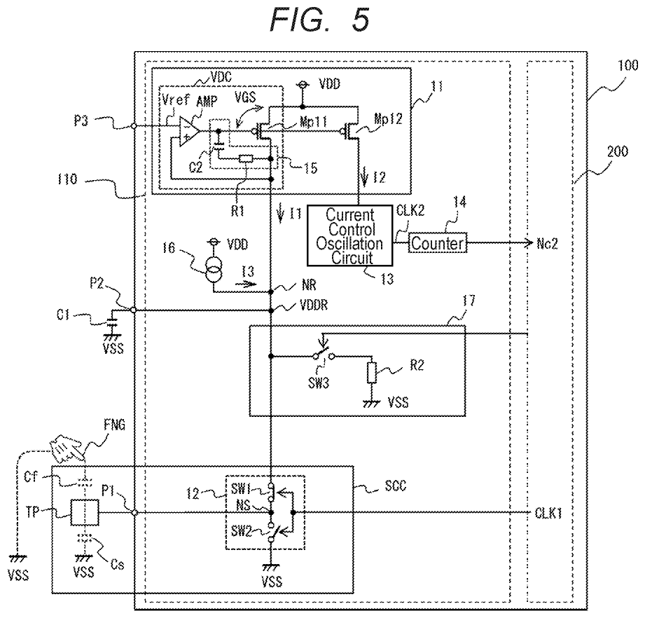

FIG. 4 shows a configuration example of the semiconductor device 100 according to this embodiment. FIG. 5 shows a configuration example of the measurement circuit 110 of the semiconductor device 100 in FIG. 4.

The semiconductor device 100 may be, for example, an MCU (Micro Controller Unit) equipped with a capacitive touch sensor circuit. The semiconductor device 100 may be composed of one or any number of semiconductor devices (e.g., semiconductor chips). For example, the semiconductor device 100 may be configured as an SoC (System on Chip).

As shown in FIGS. 4 and 5, the semiconductor device 100 includes terminals P1 to P3, a measurement circuit 110, and a control unit 200, similar to FIG. 1. The touch electrode TP is connected to terminal P1 (e.g., the first terminal). The touch electrode TP is a touch element used in, for example, touch keys, touch screens, touchless buttons, 3D gestures, and 2D gestures.

The measurement circuit 110 measures the capacitance of the touch electrode TP, similar to FIG. 1. Specifically, the measurement circuit 110 measures the current corresponding to the capacitance of the touch electrode TP. Additionally, the measurement circuit 110 switches the current path to measure the current flowing through the built-in load resistor R2 instead of the touch electrode TP.

The control unit 200 executes the control of the measurement circuit 110 and the processing required for the application. The application is, for example, a contact or non-contact application using touch keys, touch screens, touchless buttons, 3D gestures, 2D gestures, etc. The functions of the control unit 200 may be realized by hardware alone, software alone, or a combination thereof.

As shown in FIG. 4, control unit 200 includes a measurement control unit 210, a correction unit 220, and a touch determination unit 230. The measurement control unit 210 is control logic that controls the measurement operation of the measurement circuit 110. The measurement control unit 210 controls switches SW1 to SW3 in the measurement circuit 110 and switches the current path when measuring the capacitance of the touch electrode TP and when measuring the current of the built-in load resistor R2. Additionally, when measuring the capacitance of the touch electrode TP, the measurement control unit 210 supplies clock CLK1 to the switched capacitor circuit SCC and controls the charging and discharging of the capacitance of the touch electrode TP.

The correction unit 220 corrects the measurement values of the measurement circuit 110. The correction unit 220 corrects the measured value of the capacitance of the touch electrode TP based on the measured value of the current of the built-in load resistor R2.

The touch determination unit 230 performs touch determination based on the corrected measured value of the capacitance of the touch electrode TP. The touch determination unit 230 determines the presence or absence of a touch by comparing the difference between the corrected measured value of the capacitance of the touch electrode TP and a reference value with a threshold. Additionally, the touch determination unit 230 maintains the touch determination result based on the variation in the measured value of the current of the built-in load resistor R2.

As shown in FIG. 5, the measurement circuit 110 includes a current mirror circuit 11, a switch circuit 12, a current-controlled oscillation circuit 13, and a counter 14, similar to FIG. 1. The measurement circuit 110 further includes an offset current source 16 and a test circuit 17.

The offset current source 16 generates an offset current I3 from the power supply voltage VDD. The offset current source 16 supplies the generated offset current I3 to node NR. That is, current I1+I3 is supplied to the switched capacitor circuit SCC or the built-in load resistor R2.

The test circuit 17 includes a switch SW3 and a built-in load resistor R2. For example, the built-in load resistor R2 is a resistive element for testing the load current characteristics of the current mirror circuit 11 before shipment. The built-in load resistor R2 can also be used to calibrate the oscillation characteristics of the current-controlled oscillation circuit 13. One end of switch SW3 is connected to node NR. The other end of switch SW3 is connected to one end of the built-in load resistor R2. The other end of the built-in load resistor R2 is applied to the power supply voltage VSS. Note that the built-in load resistor R2 can be used for purposes other than testing, as long as it can be used for the capacitance correction of the touch electrode TP.

The conductive and non-conductive states of switch SW3 are controlled by the measurement control unit 210. When measuring the capacitance of the touch electrode TP, switch SW3 is set to a non-conductive state (off), and current I1+I3 is supplied to the switched capacitor circuit SCC. For example, the current path through which current I1+I3 flows to the switched capacitor circuit SCC is the first current path. When measuring the current of the built-in load resistor R2, switch SW3 is set to a conductive state (on), switch SW1 is set to a non-conductive state, and current I1+I3 is supplied to the built-in load resistor R2. For example, the current path through which current I1+I3 flows to the built-in load resistor R2 is the second current path. Additionally, the measurement control unit 210 adjusts the offset current I3 generated by the offset current source 16 so that the same current is supplied during the capacitance measurement of the touch electrode TP and the current measurement of the built-in load resistor R2.

The semiconductor device 100 charges and discharges the touch electrode TP with current I1 from the current mirror circuit 11 and measures current I2, which is equal to current I1, using counter 14. This allows for the periodic measurement of the capacitance of the touch electrode TP and the detection of whether it has been touched based on changes in the measurement results.

For example, suppose ripple noise is applied to the power supply voltage VDD of the current mirror circuit 11. In that case, as explained in the examined example above, the gate-source voltage VGS of the p-type transistor Mp11 fluctuates due to the side effects of the phase compensation circuit 15 that suppresses the oscillation of the amplifier AMP. As a result, I1≠I2, leading to a problem where the counter 14 cannot accurately measure the value of current I1.

Therefore, in this embodiment, the built-in load resistor R2 is used to test the load current characteristics of the current mirror circuit 11 before shipment. Since both the capacitance measurement of the touch electrode TP and the current measurement of the built-in load resistor R2 use current I1, both measurement values are equally affected by ripple noise. Utilizing this, the current measurement of the built-in load resistor R2 is added during the sequence in which the user periodically measures the capacitance of the touch electrode TP. The current measurement value of the built-in load resistor R2 is used to correct the capacitance measurement value of the touch electrode.

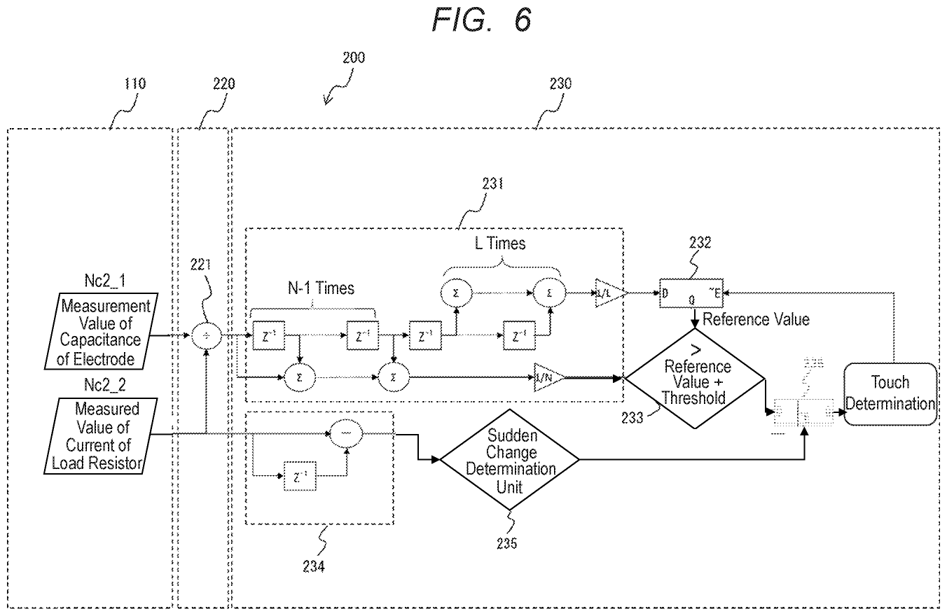

FIG. 6 shows a configuration example of the correction unit 220 and the touch determination unit 230 in the control unit 200 according to this embodiment.

The measurement circuit 110 outputs the measured value of the capacitance of the touch electrode TP, that is, the measured value of the current flowing through the touch electrode TP in the first current path (count number Nc2_1, for example, the first current measurement value). Additionally, the measurement circuit 110 outputs the measured value of the current flowing through the built-in load resistor R2 in the second current path (count number Nc2_2, for example, the second current measurement value). For example, measurement circuit 110 is realized by hardware. The measurement values output from the measurement circuit 110 are digital values.

The correction unit 220 corrects the measured value of the capacitance of the touch electrode TP (count number Nc2_1) using the measured value of the current of the built-in load resistor R2 (count number Nc2_2). For example, the correction unit 220 is a HAL (Hardware Abstraction Layer) and is realized by software or hardware.

The correction unit 220 includes, for example, a division circuit 221. The division circuit 221 divides the measured value of the capacitance of the touch electrode TP by the measured value of the current of the built-in load resistor R2. The correction unit 220 may be a subtraction circuit instead of a division circuit. That is, the measured value of the current of the built-in load resistor R2 may be subtracted from the measured value of the capacitance of the touch electrode TP. Even in the case of subtraction, correction can be performed similarly to division, reducing the amount of computation.

The touch determination unit 230 includes a moving average calculation unit 231, a reference value setting unit 232, and a capacitance determination unit 233, similar to FIG. 2. The touch determination unit 230 further includes a variation calculation unit 234, a sudden change determination unit 235, and a determination maintenance unit 236. The touch determination unit 230 is a function of the application layer of a capacitive touch sensor. For example, the touch determination unit 230 is realized by software.

The moving average calculation unit 231, the reference value setting unit 232, and the capacitance determination unit 233 have the same configuration as in FIG. 2, but are not limited to these configurations. Other configurations may be used as long as the necessary functions can be realized according to the application.

Similar to FIG. 2, the moving average calculation unit 231 calculates the moving average of the corrected measured value of the capacitance of the touch electrode TP. The reference value setting unit 232 sets the moving average result of the corrected measured value of the capacitance of the touch electrode TP as a reference value in the capacitance determination unit 233. The capacitance determination unit 233 compares the moving average result of the measurement value to be determined with the reference value+threshold and determines the presence or absence of a touch based on the comparison result. Additionally, the reference value setting unit 232 does not update the reference value during the period when the capacitance determination unit 233 determines a touch state.

The variation calculation unit 234 calculates the variation in the measured value of the current of the built-in load resistor R2. For example, the variation calculation unit 234 calculates the first derivative of the measured value of the current of the built-in load resistor R2. For example, the variation calculation unit 234 calculates the difference between the previous measurement value and the current measurement value. In addition to the first derivative, other methods may be used to calculate the variation in the measurement values over a predetermined period.

The sudden change determination unit 235 determines sudden changes in the measured value of the current of the built-in load resistor R2. For example, the sudden change determination unit 235 compares the calculated variation (first derivative value) with a threshold for variation determination, and if the calculated variation is greater than the threshold, it determines that a sudden change has occurred. The determination maintenance unit 236 maintains the previous touch determination result determined by the capacitance determination unit 233 if it is determined that the measured value of the current of the built-in load resistor R2 has suddenly changed. That is, the determination maintenance unit 236 continues to output the previous touch determination result of the capacitance determination unit 233.

The operating principle of the correction unit 220 and the touch determination unit 230 in FIG. 6 is explained. The measurement circuit 110 successively switches switches SW1, SW2, and SW3. The measurement circuit 110 outputs the count number Nc2_1 of current I2 when charging the touch electrode TP and the count number Nc2_2 of current I2 when the current path is switched to the built-in load resistor R2. The measurement circuit 110 outputs discrete measurement data sequences Nc2_1[k] and Nc2_2[k] (k=0,1,2, . . . ) for each count number.

Both count numbers Nc2_1 and Nc2_2 are measured values of current I2 affected by the same power supply ripple or temperature. Therefore, division circuit 221 calculates the quotient of count numbers Nc2_1[k] and Nc2_2[k]. In the touch determination unit 230, it becomes possible to determine a touch by using the obtained data sequence, removing the influence of power supply ripple or temperature.

However, since the count numbers Nc2_1[k] and Nc2_2[k] cannot be measured simultaneously, there is a time difference. If the magnitude of the power supply ripple or temperature fluctuates rapidly during the time difference, only one of the count numbers Nc2_1[k] or Nc2_2[k] will be affected by the fluctuation. Therefore, the quotient of the count numbers Nc2_1[k] and Nc2_2[k] fluctuates significantly. To prevent this fluctuation from being erroneously detected as a touch state, the variation calculation unit 234 calculates the first derivative of the count number Nc2_2 data sequence. When the sudden change determination unit 235 detects a sudden change in the power supply ripple from the first derivative calculation result, the determination maintenance unit 236 temporarily invalidates the touch detection determination and maintains the previous touch detection result as is.

The process of obtaining the quotient in the correction unit 220 or the process of obtaining the first derivative in the variation calculation unit 234 may use a more advanced digital filter. Additionally, processes such as noise removal or hysteresis deadband may be added before and after processing the measured values to improve determination accuracy. These processes may be consolidated into several digital filters and processed simultaneously.

Next, a specific example of the operation of the semiconductor device 100 according to the present embodiment will be described in comparison with the semiconductor device 900 related to the examined example. It should be noted that the following example is an example of operation when the temperature and humidity do not change, but similar operation occurs when the temperature and humidity change.

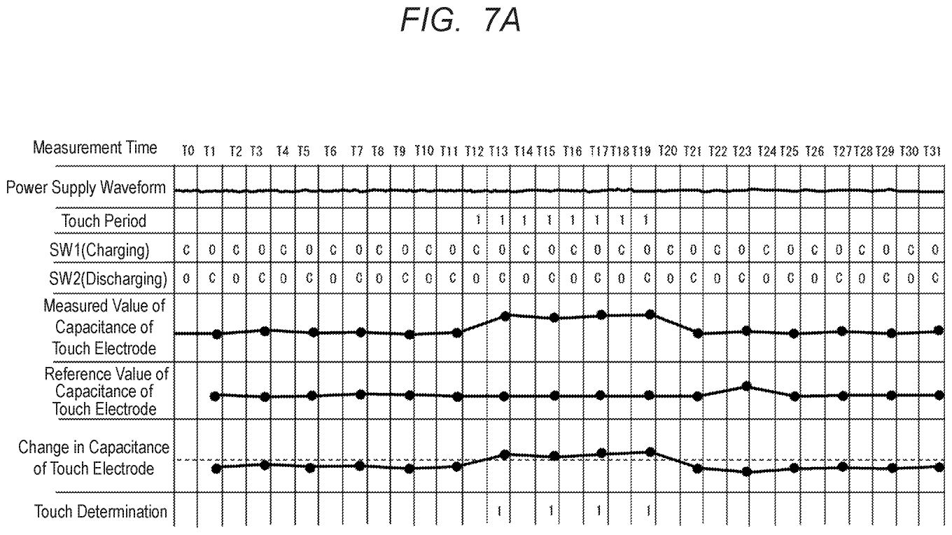

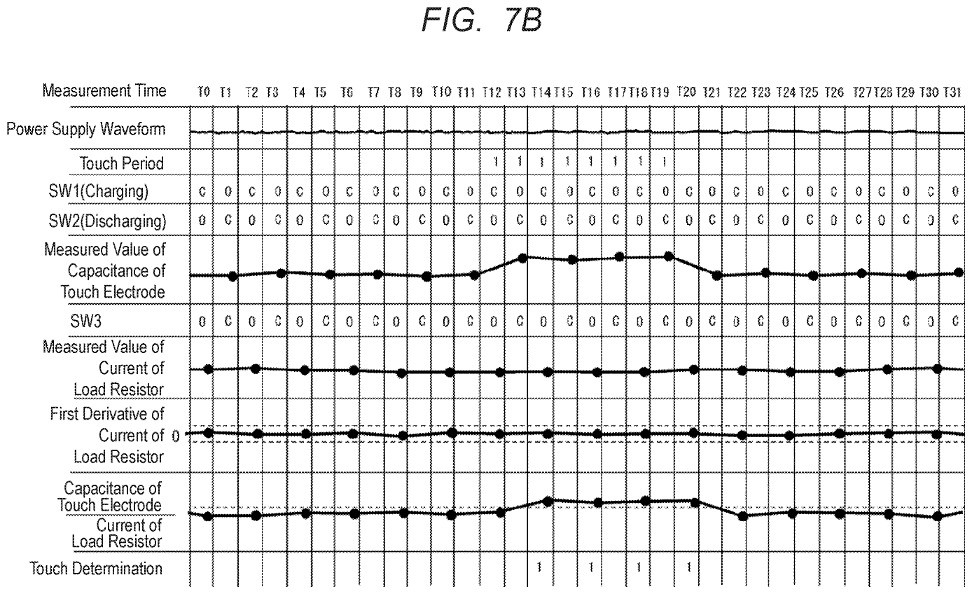

FIGS. 7A and 7B are examples of the operation of the semiconductor device 900 related to the examined example and the semiconductor device 100 according to the present embodiment when the ripple noise of the power supply voltage VDD is constant and small.

As shown in FIGS. 7A and 7B, from measurement time T0 to T31, the switches SW1 and SW2 are alternately switched on (O: Open) and off (C: Close) at each measurement time, repeating the charging and discharging of the touch electrode TP. The capacitance of the touch electrode TP is measured during the charging period of the touch electrode TP. It should be noted that the measurement at each measurement time ends in 5 msec. The interval between measurement times is about 20 msec, but it depends on the number of touch electrodes TP to be touch-determined.

In FIGS. 7A and 7B, the ripple noise of the power supply voltage VDD is constant and small. At this time, the period from measurement time T12 to T19 is set as the touch period for touching the touch electrode TP (indicated as “1” in the figure). Then, during the period from measurement time T13 to T19, the measured value of the capacitance of the touch electrode TP increases.

As shown in FIG. 7A, in the examined example, the update of the reference value is stopped during the touch determination period, so the reference value of the capacitance of the touch electrode TP does not change during the period from measurement time T12 to T19. In this case, the change in the capacitance of the touch electrode TP (measured value-reference value) exceeds the threshold during the period from measurement time T13 to T19, so it is determined as touched (touch state) (indicated as “1” in the figure).

As shown in FIG. 7B, in the present embodiment, the switch SW3 is turned on in synchronization with the discharge period of the touch electrode TP, and the current of the load resistor R2 is measured. In this case, the measured value of the current of the load resistor R2 does not change because the ripple noise of the power supply voltage VDD is small. Therefore, the first derivative of the measured value of the current of the load resistor R2 is also within the range of the upper and lower limits of the threshold.

(Measured value of the capacitance of the touch electrode TP)/(Measured value of the current of the load resistor R2) increases during the period from measurement time T14 to T20, similar to the measured value of the capacitance of the touch electrode TP, because the measured value of the current of the load resistor R2 does not change. Then, (Measured value of the capacitance of the touch electrode TP)/(Measured value of the current of the load resistor R2) exceeds the threshold during the period from measurement time T14 to T20, so it is determined as touched (touch state). As shown in FIGS. 7A and 7B, when the ripple noise of the power supply voltage VDD is constant and small, touch determination can be performed without problems in both the examined example and the present embodiment.

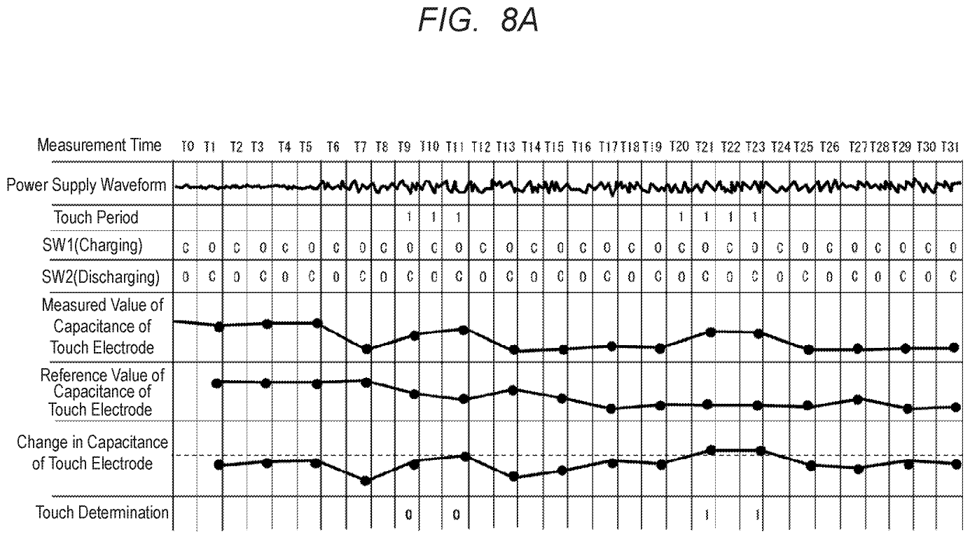

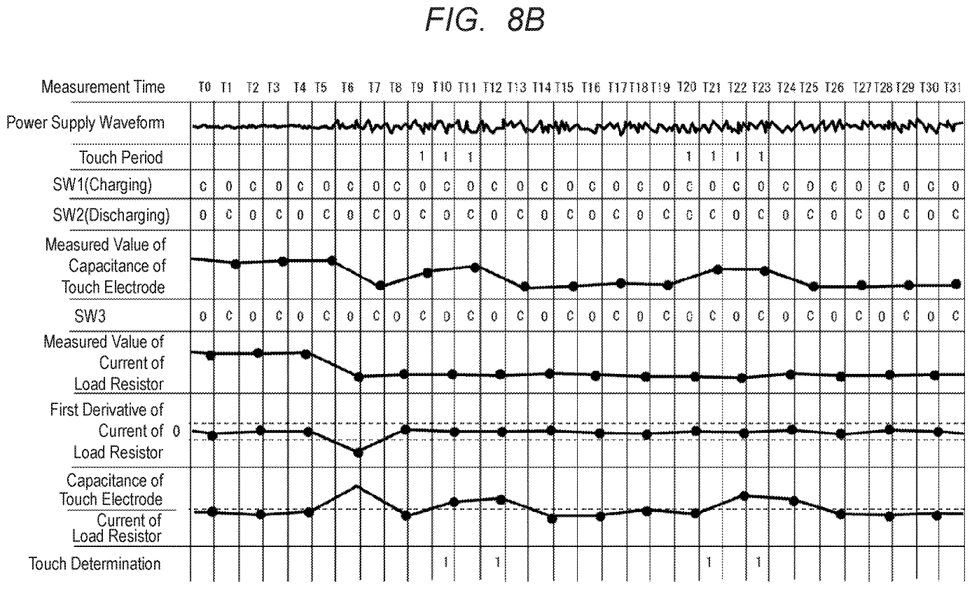

FIGS. 8A and 8B are examples of the operation of the semiconductor device 900 related to the examined example and the semiconductor device 100 according to the present embodiment when the ripple noise of the power supply voltage VDD changes from a small state to a large state.

In FIGS. 8A and 8B, the ripple noise of the power supply voltage VDD is small until measurement time T5 and becomes large from measurement time T6. At this time, the periods from measurement time T9 to T11 and from measurement time T20 to T23 are set as touch periods. When the ripple noise of the power supply voltage VDD changes from a small state to a large state, the measured value of the capacitance of the touch electrode TP decreases. In this example, the measured value of the capacitance of the touch electrode TP decreases from measurement time T6.

As shown in FIG. 8A, in the examined example, the reference value of the capacitance of the touch electrode TP is determined by the moving average of the measured value of the capacitance of the touch electrode TP, so it takes time for the reference value to decrease. In this case, the reference value of the capacitance of the touch electrode TP gradually decreases from measurement time T9 and reaches its lowest state at measurement time T17.

Then, the change in the capacitance of the touch electrode TP (measured value−reference value) does not exceed the threshold from measurement time T9 to T11, so it is erroneously determined as not touched (non-touch state) even though it is touched. Subsequently, from measurement time T21 to T23, the reference value is updated, and the change in the capacitance of the touch electrode TP (measured value-reference value) exceeds the threshold, so it is determined as touched (touch state).

As shown in FIG. 8B, in the present embodiment, the measured value of the current of the load resistor R2 decreases when the ripple noise changes from a small state to a large state, similar to the measured value of the capacitance of the touch electrode TP. In this example, the measured value of the current of the load resistor R2 also decreases from measurement time T6.

Then, the first derivative of the measured value of the current of the load resistor R2 exceeds the threshold at measurement time T6. Therefore, during the period when the first derivative of the measured value of the current of the load resistor R2 exceeds the upper and lower limits of the threshold, the touch determination is invalidated, and the previous determination result is used as is. In this example, (Measured value of the capacitance of the touch electrode TP)/(Measured value of the current of the load resistor R2) exceeds the threshold at measurement time T6, but the previous determination result is used as is, and it is determined as not touched (non-touch state).

(Measured value of the capacitance of the touch electrode TP)/(Measured value of the current of the load resistor R2) can remove the influence of ripple noise by the measured value of the current of the load resistor R2. Therefore, it exceeds the threshold during the periods from measurement time T10 to T12 and from measurement time T21 to T23 and is determined as touched (touch state).

As described above, when the ripple noise of the power supply voltage VDD changes from a small state to a large state, the measured value of the capacitance of the touch electrode TP decreases. If this decrease is large enough to be non-negligible compared to the increase in the measured value when touched, the examined example cannot detect the touch immediately after the state changes. If enough time passes after the measured value of the capacitance of the touch electrode TP changes, the correction of the reference value in the examined example will catch up, allowing touch detection. However, it is difficult to adjust the algorithm to appropriately correct the reference value in all situations.

In the present embodiment, the calculated value of (Measured value of the capacitance of the touch electrode TP)/(Measured value of the current of the load resistor R2) is used for touch detection. Since both the denominator and numerator decrease at the same rate due to the influence of ripple noise, this calculation can remove the influence of ripple noise. Therefore, even if the ripple noise of the power supply voltage VDD decreases from a small state to a large state, accurate touch determination can be made.

It should be noted that (the capacitance of the touch electrode TP) and (the current of the load resistor R2) cannot be measured simultaneously. Therefore, if the ripple noise changes rapidly from a small state to a large state during the measurement, (Measured value of the capacitance of the touch electrode TP)/(Measured value of the current of the load resistor R2) becomes an abnormal value. This problem can be avoided by detecting the rapid change in the state of the ripple noise by the magnitude of the first derivative of the measured value of the current of the load resistor R2 and temporarily invalidating the touch determination while it is changing rapidly.

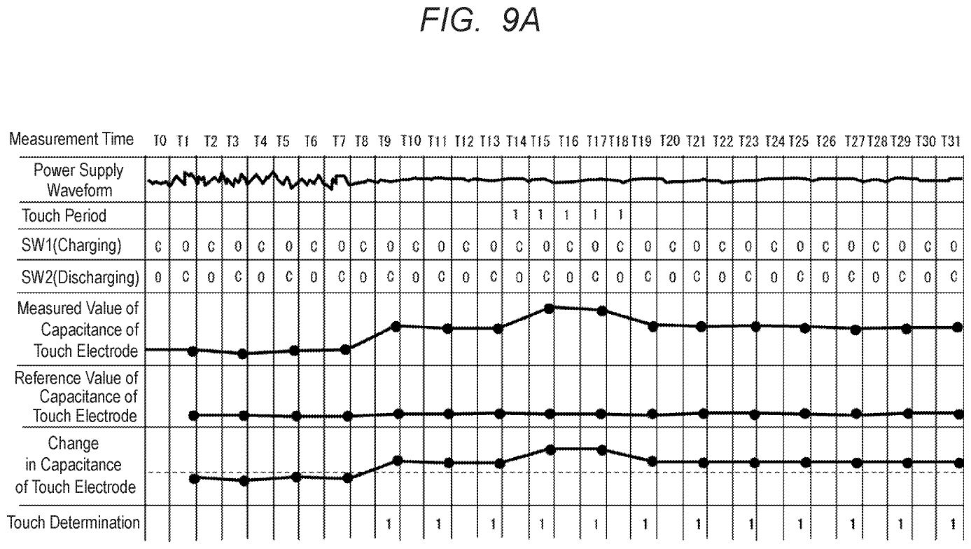

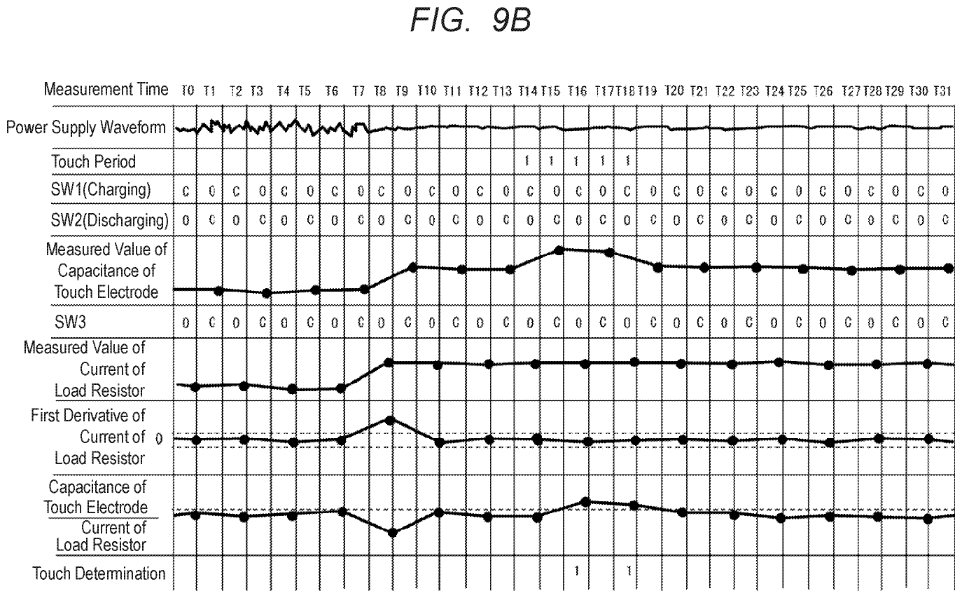

FIGS. 9A and 9B are examples of the operation of the semiconductor device 900 related to the examined example and the semiconductor device 100 according to the present embodiment when the ripple noise of the power supply voltage VDD changes from a large state to a small state.

In FIGS. 9A and 9B, the ripple noise of the power supply voltage VDD is large until measurement time T7 and becomes small from measurement time T8. At this time, the period from measurement time T14 to T18 is set as the touch period. When the ripple noise of the power supply voltage VDD changes from a large state to a small state, the measured value of the capacitance of the touch electrode increases even if it is not touched. In this example, the measured value of the capacitance of the touch electrode TP increases from measurement time T8.

As shown in FIG. 9A, in the examined example, the update of the reference value is stopped during the touch determination period, so the reference value of the capacitance of the touch electrode TP does not change after measurement time T8. Then, the change in the capacitance of the touch electrode TP (measured value-reference value) exceeds the threshold during the period after measurement time T8, so it is determined as touched (touch state). It continues to be determined as touched even if it is not touched.

As shown in FIG. 9B, in the present embodiment, the measured value of the current of the load resistor R2 increases when the ripple noise changes from a large state to a small state, similar to the measured value of the capacitance of the touch electrode TP. In this example, the measured value of the current of the load resistor R2 also increases from measurement time T8.

Thus, the first derivative of the current measurement value of the load resistor R2 exceeds the threshold at measurement time T8. Therefore, during the period when the first derivative of the current measurement value of the load resistor R2 exceeds the upper and lower limits of the threshold, the touch determination is invalidated, and the previous determination result is used as is. In this example, at measurement time T8, the previous determination result is used as is, and it is determined that there is no touch (non-touch state).

(The measurement value of the capacitance of the touch electrode TP)/(the measurement value of the current of the load resistor R2) can remove the influence of ripple noise from the current measurement value of the load resistor R2. Therefore, it is determined that the threshold is exceeded, and a touch (touch state) is detected during the period from measurement time T16 to T18.

Thus, when the ripple noise of the power supply voltage VDD changes from a large state to a small state, the measurement value of the capacitance of the touch electrode increases even if there is no touch, leading the examined example to erroneously detect this as a touch. Also, during the touch determination period, the update of the reference value is stopped, so it continues to be determined as a touch.

In the present embodiment, the calculated value of (the measurement value of the capacitance of the touch electrode TP)/(the measurement value of the current of the load resistor R2) is used for touch detection. Since both the denominator and the numerator decrease at the same rate due to the influence of ripple noise, this calculation can remove the influence of ripple noise. Therefore, even if the ripple noise of the power supply voltage VDD changes from a large state to a small state, an accurate touch determination can be made.

It should be noted that (the capacitance of the touch electrode TP) and (the current of the load resistor R2) cannot be measured simultaneously. Therefore, if the ripple noise changes rapidly from a large state to a small state during measurement, (the measurement value of the capacitance of the touch electrode TP)/(the measurement value of the current of the load resistor R2) becomes an abnormal value. This problem can be avoided in the same way as when the ripple noise changes from a small state to a large state.

As explained above, when ripple noise is applied to the power supply voltage of the capacitive touch sensor circuit, the measurement value of the capacitance of the touch electrode decreases due to the influence of the ripple noise. In the present embodiment, the decrease in the measurement value of the capacitance is corrected by the measurement value of the current flowing through the built-in resistor used for the pre-shipment test of the capacitive touch sensor circuit. This allows the removal of the influence of ripple noise and improves the accuracy of touch determination. Furthermore, using the built-in load resistor for pre-shipment testing eliminates the need for changes in the circuit configuration.

### Second Embodiment

Next, the second embodiment will be described. In this embodiment, an example will be described in which the measurement value of the current flowing through an external load resistor in a semiconductor device is used to correct the measurement value of the capacitance of the touch electrode. The configuration and operation other than the measurement circuit 110 are the same as in the first embodiment.

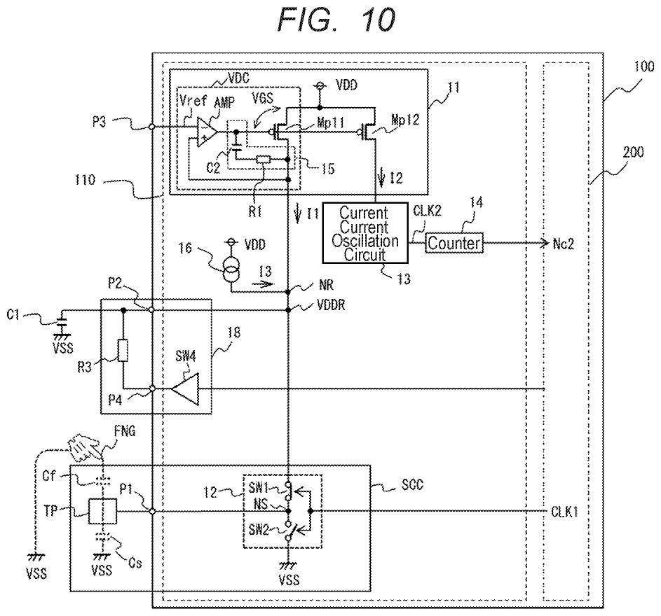

FIG. 10 shows a configuration example of the measurement circuit 110 of the semiconductor device 100 according to the present embodiment. In the example of FIG. 10, the measurement circuit 110 of the semiconductor device 100 does not include a test circuit 17 with a built-in load resistor R2, compared to the configuration of FIG. 5. Instead of the test circuit 17, a general-purpose output port 18 provided in the semiconductor device 100 is used.

The general-purpose output port 18 includes terminal P2, terminal P4 (e.g., a second terminal), and an impedance switching circuit SW4 connected to terminal P4. One end of the external load resistor R3 is connected to terminal P2, and the other end is connected to terminal P4. The impedance of the impedance switching circuit SW4 is switched by control unit 200. By switching the output impedance of the general-purpose output port 18 to low and high using the impedance switching circuit SW4, it can replace the switch SW3. That is, similar to the switch SW3 in the first embodiment, the impedance of the impedance switching circuit SW4 is switched. For example, during the capacitance measurement of the touch electrode TP, the impedance switching circuit SW4 is set to high impedance (off). This supplies current I1+I3 to the switched capacitor circuit SCC. Also, during the current measurement of the external load resistor R3, the impedance switching circuit SW4 is set to low impedance (on). This supplies current I1+I3 to the external load resistor R3. The rest is the same as in the first embodiment.

Thus, in a semiconductor device without a built-in load resistor, a load resistor is externally attached to the general-purpose output port. This allows the measurement value of the capacitance of the touch electrode to be corrected by the measurement value of the current flowing through the load resistor, similar to the first embodiment.

It should be noted that each element described and illustrated as a functional block for performing various processes can be configured in hardware as a CPU (Central Processing Unit), memory, and other circuits. In terms of software, it is realized by programs loaded into memory. Therefore, it is understood by those skilled in the art that these functional blocks can be realized in various forms by hardware alone, software alone, or a combination thereof, and the present invention is not limited to any of them.

The above programs can be stored and supplied to a computer using various types of non-transitory computer readable media. Non-transitory computer readable media includes various types of tangible storage media. Examples of non-transitory computer-readable media include magnetic recording media (e.g., flexible disks, magnetic tapes, hard disk drives), magneto-optical recording media (e.g., magneto-optical disks). Examples of non-transitory computer-readable media include CD-ROM (Read Only Memory), CD-R, CD-R/W, and semiconductor memories. Semiconductor memories include masked ROM, PROM (Programmable ROM), EPROM (Erasable PROM), flash ROM, and RAM (Random Access Memory). The programs may also be supplied to the computer by various types of transitory computer-readable transitory computer readable media. Examples of transitory computer-readable media include electrical signals, optical signals, and electromagnetic waves. The transitory computer readable medium may provide the program to the computer via wired or wireless communication paths, such as electrical wires and optical fibers.

The invention made by the inventor has been specifically described based on the embodiment. However, the present invention is not limited to the embodiment already described, and it is needless to say that various modifications can be made without departing from the gist thereof.

What is claimed is:

1. A semiconductor device comprising: a first terminal and a first current path for measuring the current flowing through a capacitive touch element connected to the first terminal, and a second current path branched from the first current path for measuring the current flowing through a resistive element instead of the touch element, and a correction unit for correcting the first current measurement value in the first current path based on the second current measurement value in the second current path.

2. The semiconductor device according to claim 1, wherein the resistive element is built into the semiconductor device.

3. The semiconductor device according to claim 2, wherein the resistive element is a resistive element for testing the characteristics of a circuit for measuring the current flowing through the first current path.

4. The semiconductor device according to claim 1, further comprising a second terminal, wherein the resistive element is connected to the second terminal.

5. The semiconductor device according to claim 1, wherein the correction unit corrects the first current measurement value by dividing it by the second current measurement value.

6. The semiconductor device according to claim 1, wherein the correction unit corrects the first current measurement value by subtracting the second current measurement value from it.

7. The semiconductor device according to claim 1, further comprising a touch determination unit for performing touch determination based on the corrected first current measurement value.

8. The semiconductor device according to claim 7, wherein the touch determination unit maintains the result of the touch determination before the second current measurement value changes significantly if the second current measurement value changes significantly from a predetermined value.

9. The semiconductor device according to claim 8, wherein the touch determination unit determines whether the second current measurement value has changed significantly from a predetermined value based on the first derivative of the second current measurement value.

10. The semiconductor device according to claim 8, wherein the touch determination unit performs the touch determination based on the difference between the corrected first current measurement value and a reference value, and the comparison result with a threshold value.

11. The semiconductor device according to claim 10, wherein the touch determination unit sets the moving average value of the corrected first current measurement value as the reference value.

12. The semiconductor device according to claim 11, wherein the touch determination unit does not update the reference value if it is determined to be in a touch state.

13. The semiconductor device according to claim 10, wherein the touch determination unit compares the difference between the moving average value of the corrected first current measurement value and the reference value with the threshold value.

14. A measurement method comprising: measuring the current flowing through a capacitive touch element in a first current path, measuring the current flowing through a resistive element instead of the touch element in a second current path branched from the first current path, and correcting the first current measurement value in the first current path based on the second current measurement value in the second current path.
